(19) United States
(12) Patent Application Publication
(10) Pub. No.: US 2015/0162797 A1
(43) Pub. Date: Jun. 11, 2015

(54) Rotor of an Electric Generator for Generating Electricity in Power Plants

(71) Applicant: Sensoplan GmbH, Hohentengen (DE)

(72) Inventor: Johann Schubert, Graz (AT)

(21) Appl. No.: 14/571,315

(22) Filed: Dec. 16, 2014

Related U.S. Application Data
(62) Division of application No. 13/497,411, filed on Mar. 21, 2012, now abandoned.

(30) Foreign Application Priority Data
Dec. 18, 2009 (DE) 10 2009 058 830.2

(51) Int. Cl. H02K 3/38; H02K 3/24

(52) U.S. Cl. CPC H02K 3/38; H02K 3/24

(57) ABSTRACT

The invention relates to a rotor of an electric generator for generating electricity in power plants, with support elements (9) having spacers (10) between the conductors (6) in the area of the winding overhang (7). The spacers (10) are distributed over the surface of the support elements (9) as island-shaped structures so that the conductors can be cooled uniformly.

### CROSS-REFERENCE TO RELATED APPLICATIONS

This application is a divisional application of U.S. application Ser. No. 13/497,411 having a filing dated of 21 Mar. 2012, which is a national stage filing of international application No. PCT/DE2010/001309 having an international filing date of 10 Nov. 2010 designating the United States, the international application claiming a priority date of 18 Dec. 2009, based on prior filed German patent application No. 10 2009 058 830.2, the entire contents of the aforesaid United Sates patent application, the aforesaid international application, and the aforesaid German patent application being incorporated herein by reference.

### BACKGROUND OF THE INVENTION

The invention concerns a rotor of an electric generator for generating electricity in power plants with a shaft, with conductors arranged on the shaft and defining a winding of coils, with plate-shaped support elements of an electrically insulating material arranged in the area of the winding overhang between parallel neighboring conductors that have projecting spacers on their topsides facing the conductors, as well as with an inlet as well as a discharge for a cooling medium, wherein the spacer areas between the conductors and the support elements define a cooling channel; the invention further concerns a method for refurbishing a winding overhang of a rotor of an electric generator for generating electricity in power plants.

Electric generators for generating electricity in power plants have a rotor. To begin with, this rotor has a shaft. On this shaft the two poles of the rotor are arranged. They each have a winding of several coils wherein each coil, in turn, is comprised of several windings. These windings are formed by electric conductors of copper that are embedded in slots. In this connection, the conductors extend parallel to the shaft between the two winding overhangs. In the winding overhangs, the conductors extend in a circular arc shape relative to the shaft axis. In this connection, in the area of these winding overhangs flat plate-shaped support elements made of an insulating material, in particular fiberglass-reinforced plastic, are arranged between the conductors. At their topsides that are facing the oppositely positioned conductors, the support elements each have projecting spacers. The conductors are resting on them. These spacers are substantially of a triangular shape and project from the circumferential edges of the support elements alternatingly in radial direction inwardly and outwardly.

During operation of the generator, electric current flows through the conductors. The electric currents are comparatively high and cause accordingly a strong heating effect. This reduces the service life as well as the operational performance. For this reason, the conductors in the rotor, in particular also in the two winding overhangs, are cooled by means of a cooling medium, in particular air or hydrogen. The intermediate space between the conductors and the support elements defines the cooling channel. The height of this cooling channel is predetermined by the thickness of the projecting spacers.

The supply of cooling medium is realized through a gap between the outer diameter of the shaft and the inner diameter of a rotor cover plate that encloses the winding overhang in axial direction. The air or hydrogen heated by the winding overhang flows out, for example, through slots in the pole area or bores in the rotor teeth at the outer diameter of the rotor coil into the air gap of the generator. The driving force for the flow is primarily the pressure difference as a result of the diameter difference at the inlet of the cold air and exit of the hot air (so-called self-conveying action of the rotor).

On the inner diameter of the winding overhang a cooling medium guide jacket is arranged and provided with oval-shaped openings that are each arranged below the 90 degree bends between two coils. Through these openings, the cooling medium flows into intermediate spaces between two coils extending in axial as well as tangential direction. The width of the intermediate spaces is determined in this connection by the aforementioned support elements in the form of support segments. They are circular arc segments with spacer elements arranged thereon. The support segments ensure a fixed seat of the coils and prevent their relative movement. At the same time, the support segments with the spacer holders positioned thereon serve as cooling channels for the cooling medium.

The cooling medium flows in this connection into the intermediate spaces along undulated lines (that are predetermined by the arrangement of the triangular spacers) in circumferential direction and enters then at the pole center into the hot gas chamber. From here the heated cooling medium flows through two slots in the pole area into the air gap of the generator and is guided from this location through appropriate passages in the lamination stack back to the generator cooler. Another portion of the cooling medium, after entering the winding overhang, is guided in axial direction also past the triangular spacers along an undulated contour. The cooling medium exits finally through bores in the rotor teeth into the air gap.

The disadvantageous undulated guiding action for the cooling air about the triangular spacers between the coils in axial as well as tangential direction causes large dead spaces and thus large surface areas that are not flowed across by the cooling medium. Since the heat dissipation is proportional to the surface area, a minimal heat dissipation results in this way. This causes an increased temperature within the conductors.

Moreover, these undulated cooling air channels cause strong gradients in the speed profile. This has the result that the thermal transmission coefficient that depends on the cooling air speed varies greatly. Areas are produced with excellent and with bad heat dissipation and thus non-uniform temperature. Temperature gradients cause thermal stress in the conductors and thus cause rough running of the rotor.

Moreover, an unfavorable sizing of the thickness of the support elements impairs a sufficient supply with cooling air. The thickness of the support elements results from the thickness of the supporting plate and the depth of the cooling channels. They are of the same size as the thickness of the flow deflection elements. Heating of the coil overhangs increases with increasing coil size. This is so because greater bracket lengths in tangential direction and in axial direction entail longer conductors and thus higher losses because the resistance increases proportional to the length. Despite of this, in the existing constructions the depth of the cooling channels for all coils is of the same size in axial direction. This is disadvantageous for larger coils.

With regard to mechanical aspects, the known support elements also have weaknesses. The great distances between the deflection elements causes the supports to be flexible. Moreover, the deflection elements in axial/tangential direction are displaced to each other. In this way, an anisotropic stiffness of the winding overhang support results. This disadvantageous support of the coils causes movements in the winding overhang in operation and thus causes rough running of the rotor.

Based on this, it is the object of the invention to provide a rotor of an electric generator for generating electricity in power plants with improved cooling action in the winding overhangs.

### SUMMARY OF THE INVENTION

The technical solution is characterized by the spacers embodied as insular structures being distributed across the surface of the support elements.

In this way, an improvement of the winding overhang cooling action of generator rotors with indirectly cooled rotor winding is provided. The basic concept of effecting the support of the coils, on the one hand, and the cooling medium guiding action, on the other hand, by one and the same component, i.e., the support elements, is maintained. However, improvements are achieved by means of the configuration as well as arrangement of the spacers in accordance with the invention. For example, the so-called dead water spaces (areas in the rotor winding overhang that are not flowed through by cooling air) are avoided by flow-optimized design of the cooling channels integrated into the support elements. This results in improved heat dissipation and more homogeneous temperature distribution in the winding as a result of a larger flowed-across surface area as a whole by avoiding these dead water spaces. A uniform spacing of the spacers ensures an interruption-free and complete flow through the cooling channels. Finally, a uniform speed profile is provided that ensures a continuous and good heat transfer. In regard to mechanical aspects, the support elements are stiff and almost isotropic because the spacings between the spacers are smaller than prior to this and all elements are oriented in axial direction.

In addition to the insular spacers of the afore described, it is also possible that peninsular structures project from the edges of the support elements into the surface of the support elements. This means that the spacers cover the entire surface area of the support elements up to the edge.

Preferably, the insular structures or peninsular structures, viewed in the flow direction of the cooling medium, have a streamlined shape. This has the advantage that the spacers constitute only a minimal flow resistance for the cooling medium.

Preferably, the spacers, viewed in the flow direction of the cooling medium, have a greater extension than in the transverse direction. In this way, a streamlined configuration is provided.

A further embodiment in this connection proposes that, viewed in a direction opposite to the flow direction, the spacers have a pointed end. This means that the cooling medium impinges on a pointed end which is extremely minimal with respect to resistance surface area. In this way, the flow resistance is further reduced.

According to another embodiment, the spacers are preferably of an oval configuration. Other streamlined profiles are conceivable.

The embodiment with displaced arrangement of the spacers has the advantage that it is ensured for all conductors that they are resting on the spacers of the support elements and not on the bottom surface of the support elements.

Another embodiment has the advantage of an effective guiding action of the cooling air. This is so because the barriers at the center are provided for discharge of hot air into the inwardly positioned hot air collecting chamber.

Another embodiment has the advantage that because of the larger cutout more cooling medium can reach the conductors that are outwardly positioned in radial direction since they are loaded more thermally.

A further embodiment provides that the height of the cooling channels increases toward the outer coils with the longer tangential brackets. In this way, more cooling air is conveyed to the locations with higher thermal loading and less cooling air to the locations with reduced thermal loading. In this connection, moreover in case of a new winding with new conductors additionally also the coil spacing can be varied and the afore described effect can be reinforced.

The embodiment according to the invention of the spacers at the support elements can be used in connection with new generators. However, it can be provided also that, when refurbishing the winding overhang of a rotor of an electric generator for generating electricity in power plants, the old known support elements can be replaced with the support elements according to the invention provided with the special spacers.

In this connection, another embodiment proposes that for a new winding with new conductors also the coil spacings can be varied additionally. In this way, the described effect with regard to the cooling performance can be reinforced.

### BRIEF DESCRIPTION OF THE DRAWINGS

An embodiment of a rotor according to the invention of an electrical generator for generating electricity in power plants will be explained in the following with the aid of the drawings. It is shown therein in:

FIG. 1 an overall view of a rotor of a 2-pole generator;

FIG. 2 a section of the winding overhang with the support according to the invention;

FIG. 3 a perspective schematic illustration of the winding overhang;

FIG. 4 an illustration in accordance to that of FIG. 3 but without winding;

FIG. 5a a plan view onto the winding overhang in FIG. 3;

FIG. 5b a detail of FIG. 5a;

FIG. 6a a view of a support element with the spacers according to the invention;

FIG. 6b a plan view onto the support element in FIG. 6a;

FIG. 6c an end view of the support element in FIG. 6a;

FIG. 6d a section view along the section line A-A in FIG. 6a;

FIG. 6e a perspective view of the support element;

FIG. 7 a schematic illustration of the flow about the spacers of the support elements.

### DESCRIPTION OF PREFERRED EMBODIMENTS

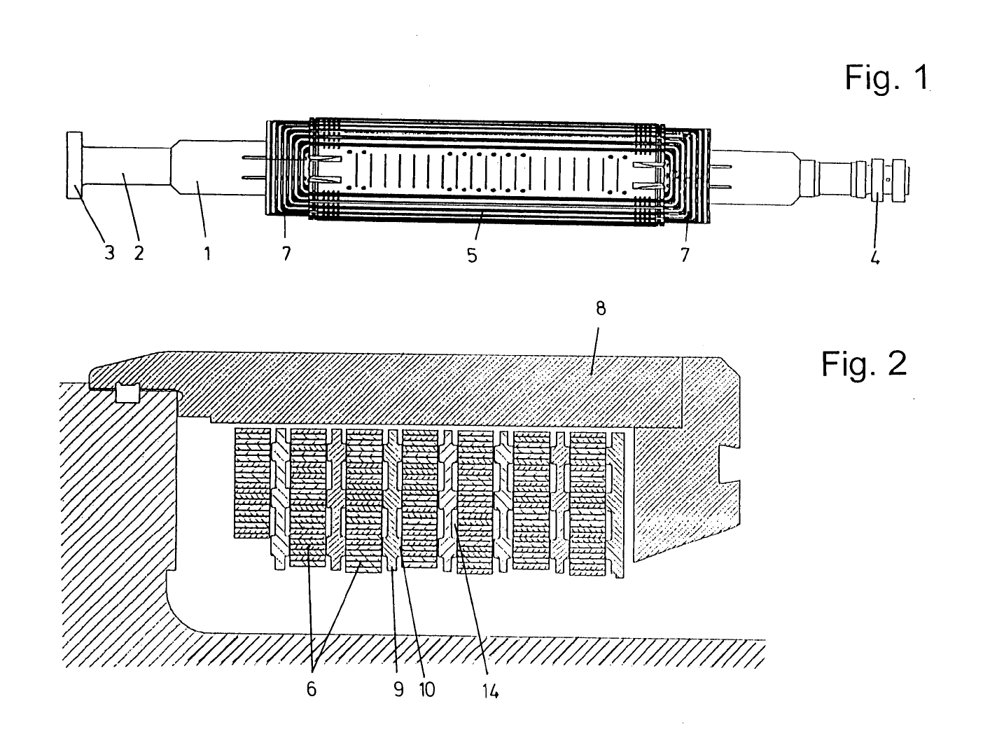

FIG. 1 shows the rotor of a 2-pole generator as a whole. In this context, the rotor has a shaft 1. The latter has at one end a bearing 2 as well as a coupling 3 for the turbine and at the other end slide rings 4. In the central area there is the rotor body with the rotor winding 5 comprised of individual conductors 6. The two ends of the rotor winding 5 form the winding overhangs 7. It can be seen additionally in FIG. 2 that the winding overhangs 7 are covered by a rotor cover 8.

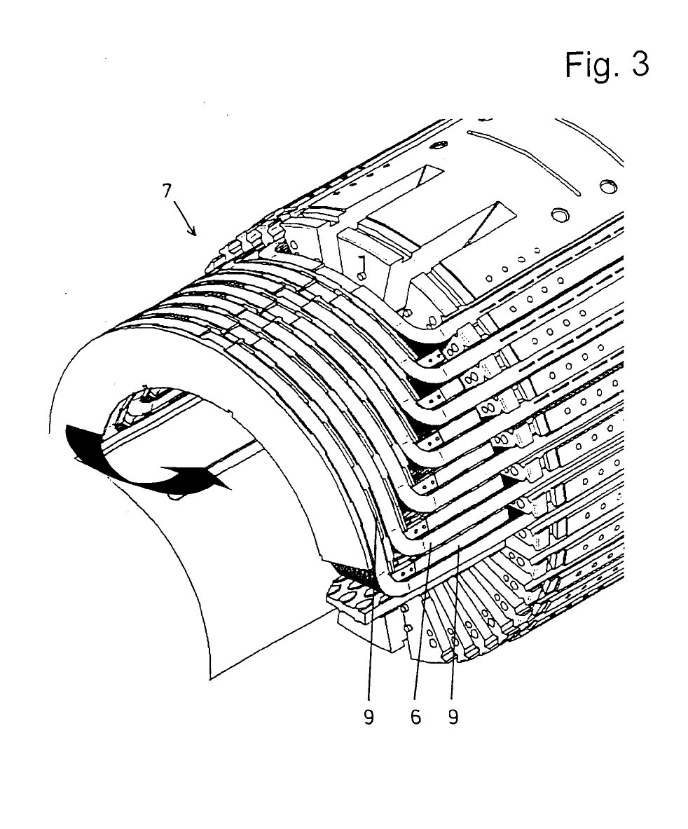

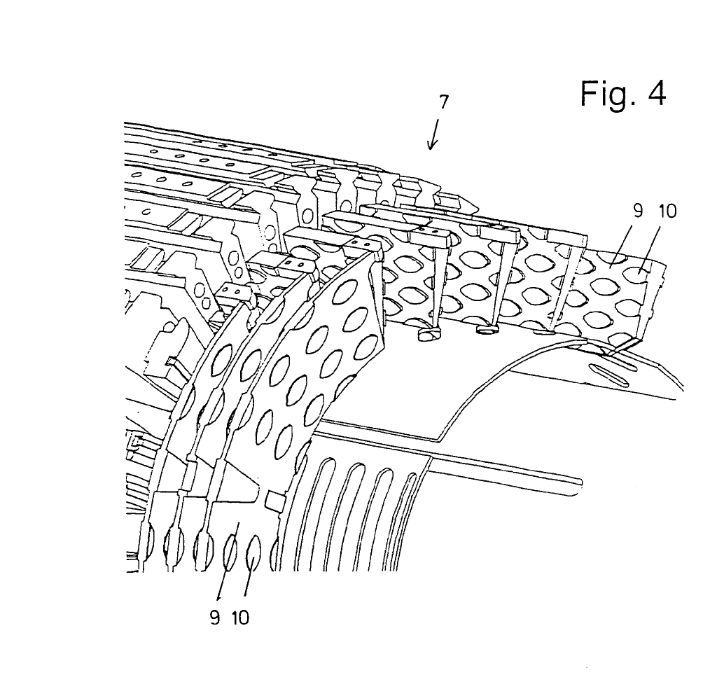

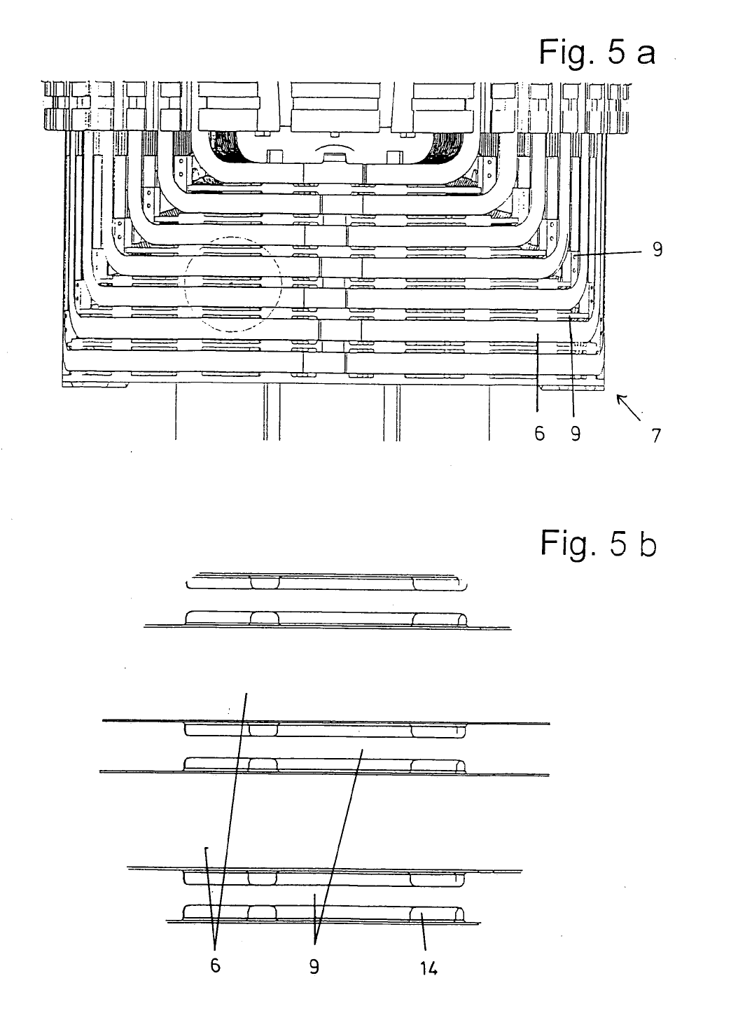

As can be seen in detail in FIGS. 3 to 5, the conductors 6 are arranged in the area of the winding overhang 7 initially straight and coaxial to the axis of the shaft 1, subsequently circular arc-shaped and concentric, and finally straight and coaxial again. In the straight area as well as in the circular arc-shaped area of the conductors 6 there are between them—in the most general sense—plate-shaped flat support elements 9 of fiberglass-reinforced plastic material or another insulating material. As especially illustrated in FIG. 4, they are embodied in the circular arc-shaped area as ring segment while in the axial area they are designed as wedge-shaped plates.

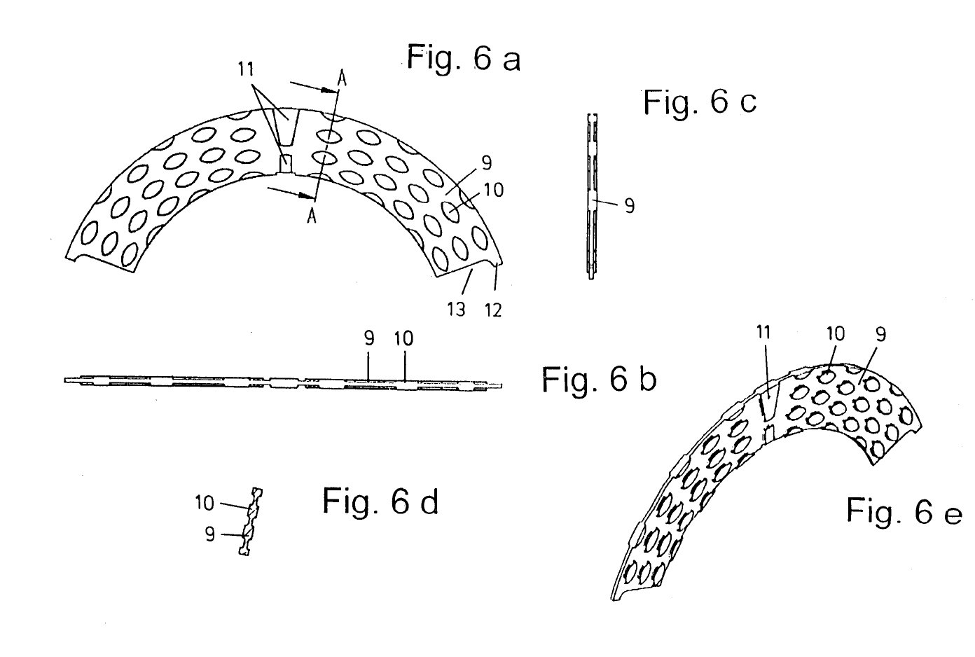

The special feature of these support elements 9 are the spacers 10 provided on both sides as they are illustrated in particular in FIGS. 6a to FIG. 6e. These spacers 10 are of a streamlined oval configuration in the embodiment. They are arranged in uniform distribution across the entire surface area of the support elements 9. In this connection, the spacers 10 are arranged additionally in displaced arrangement relative to each other along the cooling medium path.

At the center there are also barriers 11. At the end, cutouts 13 are provided with the exception of a centering nose 12.

The function is as follows.

The conductors 6 are resting on the spacers 10 of the support elements 9. Since these spacers 10 project past the base surface of the support elements 9, in the intermediate area between the conductors 6 and the support elements 9 a cooling channel 14 is defined, respectively, in the area of this base surface.

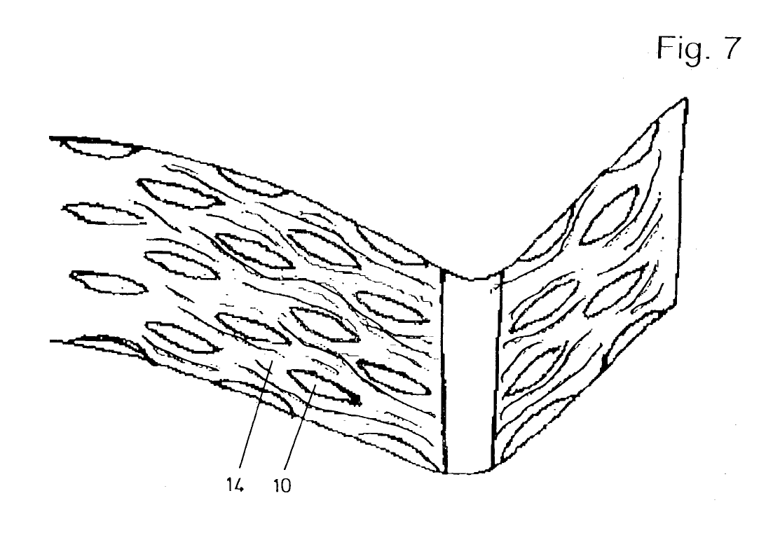

The cooling medium, in particular cooling air or hydrogen, is supplied to the winding overhang 7 as indicated in FIG. 3 by the arrow. The cooling medium flows then along the cooling channels 14 as purely schematically indicated in FIG. 7. The fish-shaped spacers 10 for the conductors 6 are flowed about by the cooling medium in a streamlined pattern and absorb thus the heat produced in the conductors 6. After passing the cooling channels 14 the heated cooling medium is then discharged from the winding overhang 7.

### LIST OF REFERENCE NUMERALS

1 shaft
2 bearing
3 coupling
4 slide ring
5 rotor winding
6 conductor
7 winding overhang
8 rotor cover
9 support element
10 spacer
11 barrier
12 centering nose
13 cutout
14 cooling channel

What is claimed is:

1. A rotor of an electric generator for generating electricity in power plants, the rotor comprising:
a shaft;
conductors arranged on the shaft and defining a winding of coils with a winding overhang;
plate-shaped support elements of an electrically insulating material arranged within the winding overhang between parallel neighboring ones of the conductors;
the support elements having projecting spacers arranged on a topside facing the conductors;
wherein in a space between the conductors and the support elements cooling channels for a cooling medium are defined between the spacers;
wherein the spacers are insular structures distributed across the surface of the support elements.

2. The rotor according to claim 1, wherein, from edges of the support elements, peninsular structures project into the surface of the support elements.

3. The rotor according to claim 2, wherein the insular structures or peninsular structures, viewed in a flow direction of the cooling medium, are embodied to be streamlined.

4. The rotor according to claim 3, wherein, in the flow direction of the cooling medium, the insular structures or peninsular structures have a greater extension than in a direction transverse to the flow direction.

5. The rotor according to claim 3, wherein the insular structures or peninsular structures have a pointed end viewed in a direction opposite to the flow direction of the cooling medium.

6. The rotor according to claim 3, wherein the insular structures or peninsular structures have an oval shape.

7. The rotor according to claim 3, wherein the spacers, in the flow direction of the cooling medium, are displaced relative to each other such that the conductors are always resting sectionwise on the spacers.

8. The rotor according to claim 3, wherein the support elements are support segments and have, at edges positioned in circumferential direction of the rotor, a cutout with a short centering nose for centering the position of the support elements.

9. The rotor according to claim 8, wherein, for the support elements embodied as support segments, a height of the cooling channels increases toward outer coils of the rotor as tangential brackets become longer.
